(19) United States
(12) Patent Application Publication
(10) Pub. No.: US 2025/0042789 A1
(43) Pub. Date: Feb. 6, 2025

(54) METHOD FOR REDUCING CONCENTRATION OF MICROORGANISM-DERIVED DISSOLVED ORGANIC NITROGEN IN WASTEWATER

(71) Applicant: Nanjing University, Nanjing (CN)

(72) Inventors: Haidong HU, Nanjing (CN); Kewei LIAO, Nanjing (CN); Hongqiang REN, Nanjing (CN)

(21) Appl. No.: 18/890,980

(22) Filed: Sep. 20, 2024

Related U.S. Application Data
(63) Continuation-in-part of application No. 17/024,656, filed on Sep. 17, 2020.
Application No. 17/024,656 is a continuation-in-part of application No. PCT/CN2019/119772, filed on Nov. 20, 2019.

(30) Foreign Application Priority Data
Sep. 12, 2019 (CN) 201910861998.7

(51) Int. Cl. C02F 3/00; C02F 1/44; C02F 3/12; C02F 101/38

(52) U.S. Cl. CPC C02F 3/006; C02F 3/12; C02F 1/44; C02F 2101/38; C02F 2209/006; C02F 2209/06; C02F 2209/08; C02F 2209/14; C02F 2209/15; C02F 2209/16; C02F 2209/22; C02F 2209/42

(57) ABSTRACT

A method for reducing mDON concentration in wastewater, including a) acquiring a kinetics associated with production and consumption of a mDON of an activated sludge system, and importing a kinetic expression of the mDON into a conventional activated sludge model No. 1 (ASM1) to build a kinetic equation for the mDON; b) inputting component variables, parameter variables, model matrices, process rate equation and operating parameters of a predictive model into a simulation software to build an ASM-mDON model; c) inputting initial values of the component variables and the parameter variables into the simulation software for model initialization; d) acquiring initial mDON kinetic and sensitivity analysis results, selecting corresponding parameters, calibrating kinetic and stoichiometric parameters of the ASM-mDON model using a parameter estimation function of the simulation software; and e) replacing the initial values of the ASM-mDON model with optimal values obtained in d).

### CROSS-REFERENCE TO RELATED APPLICATIONS

This application is a continuation-in-part of U.S. Ser. No. 17/024,656 filed on Sep. 17, 2020, now pending, which is a continuation-in-part of International Patent Application No. PCT/CN2019/119772 with an international filing date of Nov. 20, 2019, designating the United States, now pending, and further claims foreign priority benefits to Chinese Patent Application No. 201910861998.7 filed Sep. 12, 2019. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of wastewater treatment, and more particularly, to a method for reducing the concentration of microorganism-derived dissolved organic nitrogen (mDON) in wastewater and applications thereof.

The effluent of the municipal wastewater treatment plants includes dissolved organic nitrogen (DON). In general, the DON includes influent-derived dissolved organic nitrogen (inDON) which is non-degradable and microorganism-derived dissolved organic nitrogen produced in the biological sewage treatment process. Compared with inDON, mDON produced in the wastewater treatment process is more easily affected by the process parameters and conditions, and the composition and properties of mDON are closely related to the growth and metabolism of microorganisms in the biological treatment process.

Although the mDON in the sewage treatment plant has attracted increasing attention, there is no direct method to determine mDON in the sewage treatment plant.

### SUMMARY

The disclosure provides a method for reducing the concentration of microorganism-derived dissolved organic nitrogen (mDON) in wastewater. Specifically, based on the operating parameters of an activated sludge process, the component concentrations, and the kinetic and stoichiometric parameters of the influent of a sewage plant, an activated sludge model (ASM)-mDON predictive model is built.

The method comprises:
(a) integrating, by a data processor, a kinetic expression for microbial-derived dissolved organic nitrogen (mDON) into a conventional activated sludge model No. 1 (ASM1) to build an mDON predictive model;
(b) inputting into software, by the data processor, component variables, parameter variables, model matrices, process rate equations, and operational parameters of the mDON predictive model to build an ASM-mDON predictive model;
(c) inputting initial values, by the data processor, for the component variables and the parameter variables to initialize the ASM-mDON predictive model in software;
(d) running, by the data processor, a preliminary simulation of mDON kinetics; conducting, by the data processor, a sensitivity analysis; and selecting corresponding parameters that impact the predictions of the ASM-mDON predictive model based on the results from the preliminary simulation and the sensitivity analysis,
(e) calibrating, by parameter estimation feature in software, via the data processor, dynamic parameters and stoichiometric parameters in the ASM-mDON predictive model to obtain optimal values, thereby enhancing the accuracy of mDON concentration prediction;
(f) replacing, by the data processor, the initial values for the dynamic parameters and the stoichiometric parameters in the ASM-mDON predictive model with the optimal values obtained from the calibration to optimize the ASM-mDON predictive model;
(g) connecting a programmable logic controller via data signals to a dissolved oxygen sensor, a level sensor, a pH sensor, a plurality of actuators, and the data processor; collecting, by the programmable logic controller, the component variables and the parameter variables from the dissolved oxygen sensor, the level sensor, and the pH sensor; and transmitting, by the programmable logic controller, the collected data to the data processor;
(h) inputting, by the data processor, the collected component variables and the parameter variables into the ASM-mDON predictive model, and outputting an mDON concentration; and
(i) inputting variations in operational parameters of an activated sludge system into the ASM-mDON predictive model to determine the changes in mDON concentration under different operational conditions; and identifying an optimal combination of the operational parameters that effectively reduce mDON production based on the model predictions; and
(j) returning, by the data processor, the optimal combination of the operational parameters to the programmable logic controller; adjusting, by the programmable logic controller, the operational parameters of the plurality of actuators, thereby ensuring effective reduction in mDON concentration during wastewater treatment.

The activated sludge system comprises a fully mixed steady state activated sludge; the activated sludge has a sludge age of 5-30 days, and a concentration of 2000-5000 mg/L.

In c), the initial values of the parameter variables are determined with reference to “Mathematical Model for Activated Sludge”. The kinetic and stoichiometric parameters of the ASM-mDON model are classified for parameter assumption, parameter estimation, or default argument assignment.

In d), the sensitivity analysis uses the absolute-relative sensitivity equation to determine the influence of different values of an independent parameter on the estimation of the mDON.

The ASM-mDON model is used for study of the mDON released by microorganisms in the activated sludge system, and the model comprises:
seven components: heterotrophic bacteria X_{H}, autotrophic bacteria X_{A}, inert particles X_{I}, nitrate nitrogen S_{NO}, ammonia nitrogen S_{NH}, microorganism-derived dissolved organic nitrogen S_{DON}, dissolved oxygen S_{O};
five reaction processes: the growth process and endogenous respiration process of heterotrophic bacteria using ammonium chloride as a substrate; the growth process and endogenous respiration process of autotrophic bacteria using ammonium chloride as a substrate; and the ammonization process of mDON;
eighteen parameters: maximum specific growth rate \hat{μ}_{H} of heterotrophic bacteria, yield coefficient Y_{H} of heterotrophic bacteria, attenuation coefficient b_{H} of heterotrophic bacteria, half-saturation constant K_{H,NH} for ammonia nitrogen of heterotrophic bacteria, half-saturation constant K_{H,O} for dissolved oxygen of heterotrophic bacteria, maximum specific growth rate \hat{μ}_{A} of autotrophic bacteria, substrate utilization ratio f_{H,DON} of heterotrophic bacteria converting the substrates into the mDON, yield coefficient Y_{A} of autotrophic bacteria, attenuation coefficient b_{A} of autotrophic bacteria, half-saturation constant K_{A,NH} for ammonia nitrogen of autotrophic bacteria, half-saturation constant K_{A,O} for dissolved oxygen of autotrophic bacteria, substrate utilization ratio f_{A,DON} of autotrophic bacteria converting the substrates into the mDON, proportion of nitrogen i_{XB} in the organism, proportion of nitrogen i_{Xp} in the product of the organism, substrate utilization ratio f_{NO} of autotrophic bacteria converting the substrates into the nitrate nitrogen, proportion of inert particles f_{I} yielded in the organism, ammonification rate kₐ, and half-saturation constant K_{H,DON} for mDON.

The change rates of the seven components of the ASM-mDON model satisfy with the following formulas:

$${X}_{H} \text{:} \frac{{dX}_{H}}{dt} = {\hat{μ}}_{H} {M}_{H , NH} ( t ) {M}_{H , O} ( t ) {X}_{H} ( t ) - {b}_{H} {M}_{H , O} ( t ) {X}_{H} ( t ) \qquad ( 1 )$$

$${X}_{A} \text{:} \frac{{dX}_{A}}{d t} = {\hat{μ}}_{A} {M}_{A , N H} ( t ) {M}_{A , O} ( t ) {X}_{A} ( t ) - {b}_{A} {M}_{A , O} ( t ) {X}_{A} ( t ) \qquad ( 2 )$$

$${S}_{NH} \text{:} \frac{{dS}_{NH}}{dt} = - ( \frac{{f}_{H , DON}}{{Y}_{H}} + {i}_{XB} ) {\hat{μ}}_{H} {M}_{H , NH} ( t ) {M}_{H , O} ( t ) {X}_{H} ( t ) - ( \frac{{f}_{A , DON} + {f}_{N O}}{{Y}_{A}} + {i}_{XB} ) {\hat{μ}}_{A} {M}_{A , NH} ( t ) {M}_{A , O} ( t ) {X}_{A} ( t ) + {k}_{a} {M}_{H , O} ( t ) {X}_{H} ( t ) \qquad ( 3 )$$

$${S}_{DON} \text{:} \frac{{dS}_{D O N}}{dt} = \frac{{f}_{H , DON}}{{Y}_{H}} {\hat{μ}}_{H} {M}_{H , N H} ( t ) {M}_{H , O} ( t ) {X}_{H} ( t ) + \frac{{f}_{A , DON}}{{Y}_{A}} {\hat{μ}}_{A} {M}_{A , NH} ( t ) {M}_{A , O} ( t ) {X}_{A} ( t ) - {k}_{a} {M}_{H , DON} ( t ) {X}_{H} ( t ) \qquad ( 4 )$$

$${S}_{NO} \text{:} \frac{{dS}_{N O}}{dt} = \frac{{f}_{NO}}{{Y}_{A}} {\hat{μ}}_{A} {M}_{A , N H} ( t ) {M}_{A , O} ( t ) {X}_{A} ( t ) \qquad ( 5 )$$

$${X}_{I} \text{:} \frac{{dX}_{I}}{d t} = {f}_{I} {b}_{H} {M}_{H , O} ( t ) {X}_{H} ( t ) + {f}_{I} {b}_{A} {M}_{A , O} ( t ) {X}_{A} ( t ) \qquad ( 6 )$$

$${S}_{O} \text{:} \frac{{dS}_{O}}{dt} = {k}_{L} α ( {S}_{O}^{*} - {S}_{O} ) - ( 1 - \frac{2.86 {f}_{H , DON}}{{Y}_{H}} ) {\hat{μ}}_{H} {M}_{H , NH} ( t ) {M}_{H , O} ( t ) {X}_{H} ( t ) - ( 1 - \frac{2 \text{.86} {f}_{A , DON}}{{Y}_{A}} - \frac{4 \text{.57} {f}_{NO}}{{Y}_{A}} ) {\hat{μ}}_{A} {M}_{A , N H} ( t ) {M}_{A , O} ( t ) {X}_{A} ( t ) + ( {i}_{XB} - {f}_{I} {i}_{XP} ) {b}_{H} {M}_{H , O} ( t ) {X}_{H} ( t ) + ( {i}_{XB} - {f}_{I} {i}_{XP} ) {b}_{A} {M}_{A , O} ( t ) {X}_{A} ( t ) \qquad ( 7 )$$

where M_{H,NH}(t) is a Monod term determined by the substrate for the heterotrophic bacteria; M_{A,NH} (t) is a Monod term determined by the substrate for the autotrophic bacteria; M_{H,O} (t) is a Monod term determined by the dissolved oxygen for the heterotrophic bacteria; M_{A,O} (t) is a Monod term determined by the dissolved oxygen for the autotrophic bacteria; M_{H,DON} (t) is a Monod term determined by the mDON in the heterotrophic bacteria; k_{L}α is an exchange rate between the gas phase and the liquid phase; S_{O}* is the maximum solubility of oxygen.

The mDON in the wastewater is calculated using the following kinetic equation:

$$\frac{{dS}_{DON}}{dt} = \frac{{f}_{H , DON}}{{Y}_{H}} {\hat{μ}}_{H} {M}_{H , NH} ( t ) {M}_{H , O} ( t ) {X}_{H} ( t ) + \frac{{f}_{A , DON}}{{Y}_{A}} {\hat{μ}}_{A} {M}_{A , N H} ( t ) {M}_{A , O} ( t ) {X}_{A} ( t ) - {k}_{a} {M}_{H , DON} ( t ) {X}_{H} ( t ) \qquad ( 8 )$$

The single-step size of the AMS-mDON model is 0.1, and the total response time for the predictive model is the product of the calculation capacity and the single-step size.

In (g), collecting the component variables and the parameter variables comprises filtering an influent sample from a wastewater treatment plant using a membrane filter; measuring chemical oxygen demand (COD), concentrations of total nitrogen, nitrate nitrogen, nitrite nitrogen, ammonia nitrogen, and dissolved organic nitrogen of the influent sample filtered, respectively; and measuring yield coefficient Y_{H} of heterotrophic bacteria, attenuation coefficient b_{H} heterotrophic bacteria, and maximum specific growth rate \hat{μ}_{H} of heterotrophic bacteria for the activated sludge. The wastewater treatment plant operates at the ambient temperature ranging from 15 to 25° C., and an influent pH thereof is 6.0-8.0.

The membrane filter is a cellulose acetate membrane filter having pore size of 0.45 μm.

The initial values of parameter variables are determined with reference to “Mathematical Model of Activated Sludge”. The kinetic and stoichiometric parameters of the ASM-mDON model are classified for parameter assumption, parameter estimation, or default argument assignment.

The concentration of the dissolved organic nitrogen is the difference between the total nitrogen and ammonia nitrogen, nitrate nitrogen and nitrite nitrogen; the concentration of total nitrogen is measured by using potassium persulfate oxidation-ion chromatography, or potassium persulfate oxidation-ultraviolet spectrophotometry; the concentration of ammonia nitrogen is measured by using salicylic acid-hypochlorite spectrophotometry; the nitrate nitrogen is measured by using the ion chromatography or ultraviolet-visible spectrophotometry; the nitrite nitrogen is measured by using ion chromatography or N-(1-naphthyl)-ethylenediamine spectrophotometry; and the COD is measured by using potassium dichromate method or rapid digestion method.

The following advantages are associated with the method for building a predictive model of mDON in wastewater in accordance with the disclosure:
(1) The ASM-mDON model can predict the concentration of the mDON in the wastewater, distinguish the mDON from the inDON, and quantify the concentration of the mDON released from the activated sludge in the wastewater treatment plant.
(2) The method uses a simplified ASM model, and necessary kinetic and stoichiometric parameters to build an ASM-mDON model for predicting the concentration of the mDON in the wastewater, which simplifies the operations and improves the prediction accuracy.
(3) The method can be widely applied in simulating and predicting the concentration of the mDON, laying the foundation for optimization of water quality in the wastewater treatment plants.

### BRIEF DESCRIPTION OF THE DRAWINGS

FIG. 1 is a graft showing the predictive result of the concentration of the mDON according to one embodiment of the disclosure; and

FIG. 2 is a graft showing the predictive result of the concentration of the mDON according to verification embodiment of the disclosure.

### DETAILED DESCRIPTION

To further illustrate the disclosure, embodiments detailing a method for reducing mDON concentration in wastewater are described below. It should be noted that the following embodiments are intended to describe and not to limit the disclosure.

### Example 1

The example was a simulation of the operation of a laboratory-scale sequencing batch reactor (SBR) for the treatment of activated sludge. As a raw material, the wastewater containing particular compositions (excluding dissolved organic nitrogen) was prepared to support the growth of microorganisms in the activated sludge. The prepared wastewater contained the following compositions: 300±30 mg/L COD, 20±5 mg/L total nitrogen, and 3.5±0.5 mg/L total phosphorus. The operating parameters of the sequencing batch reactor: the effective volume of 2 L, the operating cycle of 6 h, and the hydraulic retention time of 12 h, and the activated sludge age of 20 d. The operating mode of the sequencing batch reactor at ambient temperature of 25° C.: the inlet valve opens and the influent was filled in, followed by mixing and aeration for 300 min. The mixed liquor was sedimented for 50 min and the supernatant was drained out of the sequencing batch reactor. The activated sludge concentration is within the range of 2000±200 mg/L, and a pH value of 7.5±0.5. The term “hydraulic retention time”, as used herein, refers to the average time that wastewater remains in the SBR. The term “activated sludge age”, as used herein, refers to the average time a particle of suspended solids remains in an activated sludge system. The term “activated sludge concentration”, as used herein, refers to the concentration of suspended solids in the activated sludge system. The term “daily nitrogen load”, as used herein, refers to the amount of nitrogen that is introduced into the activated sludge system. Within the wastewater treatment system, a programmable logic controller is connected via data signals to a dissolved oxygen sensor, a level sensor, a pH sensor, a plurality of actuators, and a data processor. The dissolved oxygen sensor is configured to measure the concentration of dissolved oxygen in the prepared wastewater. The pH sensor is configured to measure the pH level of the activated sludge in the SBR. The level sensor is configured to continuously monitor the liquid level within various stages of the wastewater treatment process. The plurality of actuators are configured to control various processes such as flow, level, aeration, and sludge handling. The data processor is configured to build an ASM-mDON model and analyzes the data transmitted from the programmable logic controller. The plurality of actuators include, but are not limited to, an influent pump, an effluent pump, a sludge discharge valve, an aeration blower, and a sludge recirculation pump. The programmable logic controller collects the component variables and the parameter variables from the dissolved oxygen sensor, the level sensor, and the pH sensor, and then transmits the collected data to the data processor. The data processor analyzes the component variables and the parameter variables and returns an optimal combination of the operational parameters to the programmable logic controller. Upon receiving the optimal operational variables, the programmable logic controller manages the plurality of actuators by sending specific commands to start, stop, or adjust their operating levels, thereby ensuring effective reduction in mDON concentration during wastewater treatment. A method for reducing mDON concentration in wastewater comprises:

### 1. Building the ASM-mDON Model:

The inputs to the ASM-mDON model comprise: X_{H} (concentration of heterotrophic bacteria), X_{A} (concentration of autotrophic bacteria), X_{I}(concentration of inert particles), S_{NO}(concentration of nitrate nitrogen), S_{NH} (concentration of ammonia nitrogen), S_{DON}(concentration of the mDON), S_{O}(concentration of dissolved oxygen), which were state variables; the model matrix corresponding to the process rate equation for the components were inputted into the reaction process included in the software, thereby building a simulation of the sequencing batch reactor for the treatment of activated sludge.

The simulation model was the simplified ASM-mDON model as shown in Table 1:

TABLE 1
Process rate equations for components

| Components | Process rate equation | No. |
|---|---|---|
| X_{H} | $\frac{{dX}_{H}}{dt} = {\hat{μ}}_{H} {M}_{H , NH} ( t ) {M}_{H , O} ( t ) {X}_{H} ( t ) - {b}_{H} {M}_{H , O} ( t ) {X}_{H} ( t ($ | (1) |
| X_{A} | $\frac{{dX}_{A}}{dt} = {\hat{μ}}_{A} {M}_{A , NH} ( t ) {M}_{A , O} ( t ) {X}_{A} ( t ) - {b}_{A} {M}_{A , O} ( t ) {X}_{A} ( t )$ | (2) |
| S_{NH} | $\frac{{dS}_{NH}}{dt} = - ( \frac{{f}_{H , DON}}{{Y}_{H}} + {i}_{XB} ) {\hat{μ}}_{H} {M}_{H , NH} ( t ) {M}_{H , O} ( t ) {X}_{H} ( t ) - ( \frac{{f}_{A , DON} + {f}_{NO}}{{Y}_{A}} + {i}_{XB} ) {\hat{μ}}_{A} {M}_{A , NH} ( t ) {M}_{A , O} ( t ) {X}_{A} ( t ) + {k}_{a} {M}_{H , DON} ( t ) {X}_{H} ( t )$ | (3) |
| S_{DON} | $\frac{{dS}_{DON}}{dt} = \frac{{f}_{H , DON}}{{Y}_{H}} {\hat{μ}}_{H} {M}_{H , NH} ( t ) {M}_{H , O} ( t ) {X}_{H} ( t ) + \frac{{f}_{A , DON}}{{Y}_{A}} {\hat{μ}}_{A} {M}_{A , NH} ( t ) {M}_{A , O} ( t ) {X}_{A} ( t ) - {k}_{a} {M}_{H , DON} ( t ) {X}_{H} ( t )$ | (4) |
| S_{NO} | $\frac{{dS}_{NO}}{dt} = \frac{{f}_{NO}}{{Y}_{A}} {\hat{μ}}_{A} {M}_{A , NH} ( t ) {M}_{A , O} ( t ) {X}_{A} ( t )$ | (5) |
| X_{I} | $\frac{{dX}_{I}}{dt} = {f}_{I} {b}_{H} {M}_{H , O} ( t ) {X}_{H} ( t ) + {f}_{I} {b}_{A} {M}_{A , O} ( t ) {X}_{A} ( t )$ | (6) |

where M_{H,NH}(t) is the Monod term determined by the substrate for the heterotrophic bacteria; M_{A,NH} (t) is the Monod term determined by the substrate for the autotrophic bacteria; M_{H,O} (t) is the Monod term determined by the dissolved oxygen for the heterotrophic bacteria; M_{A,O} (t) is the Monod term determined by the dissolved oxygen for the autotrophic bacteria; M_{H,DON} (t) is the Monod term determined by the mDON in the heterotrophic bacteria; k_{L}α is the exchange rate between the gas phase and the liquid phase; S_{O}* is the maximum solubility of oxygen.

The model matrix corresponding to the process rate equation for the components were shown in Table 2:

TABLE 2
Matrix imported into reaction process included in software

| Reaction | | | | | | | | |
|---|---|---|---|---|---|---|---|---|
| process | X_{H} | X_{A} | S_{NH} | S_{DON} | S_{NO} | X_{I} | S_{O} | Process rate equation |
| Growth of heterotrophic | 1 | | $- \frac{{f}_{H , DON}}{{Y}_{H}} - {i}_{XB}$ | $\frac{{f}_{H , DON}}{{Y}_{H}}$ | | | $1 - \frac{2 \text{.86} {f}_{H , DON}}{{Y}_{H}}$ | \hat{μ}_{H} M_{H, NH}(t) M_{H,O}(t)X_{H}(t) |
| bacteria | | | | | | | | |
| Growth of autotrophic | | 1 | $- \frac{{f}_{A , DON} + {f}_{I}}{{Y}_{A}} - {i}_{XB}$ | $\frac{{f}_{A , DON}}{{Y}_{A}}$ | $\frac{{f}_{NO}}{{Y}_{A}}$ | | $1 - \frac{2 \text{.86} {f}_{A , DON}}{{Y}_{A}} - \frac{4 \text{.57} {f}_{NO}}{{Y}_{A}}$ | \hat{μ}_{A}M_{A, NH}(t)M_{A, O}(t)X_{A}(t) |
| bacteria | | | | | | | | |
| Endogenous | −1 | | | | | f_{I} | | b_{H}M_{H, O}(t)X_{H}(t) |
| respiration of | | | | | | | | |
| heterotrophic | | | | | | | | |
| bacteria | | | | | | | | |
| Endogenous | | −1 | | | | f_{I} | | b_{A}M_{A, O}(t)X_{A}(t) |
| respiration of | | | | | | | | |
| autotrophic | | | | | | | | |
| bacteria | | | | | | | | |
| Ammonization | | | 1 | −1 | | | | kₐM_{H,DON}(t)X_{H}(t) |

### 2. Determining the Components of Influent and the Values of Model Parameters of the ASM-mDON Model:

50 mL of influent was sampled directly from the sequencing batch reactor, and filtered using a cellulose acetate membrane filter having pore size of 0.45 m. The concentration of total nitrogen was 20 mg/L measured by using potassium persulfate oxidation-ion chromatography, or potassium persulfate oxidation-ultraviolet spectrophotometry; the concentration of ammonia nitrogen was 20 mg/L measured by using salicylic acid-hypochlorite spectrophotometry; the nitrate nitrogen was 0 mg/L measured by using the ion chromatography or ultraviolet-visible spectrophotometry; the nitrite nitrogen was 0 mg/L measured by using ion chromatography or N-(1-naphthyl)-ethylenediamine spectrophotometry; and the COD was 300 mg/L measured by using potassium dichromate method or rapid digestion method. The concentration of the dissolved organic nitrogen was 0 mg/L, that is, the difference between the sum of total nitrogen and ammonia nitrogen and the sum of nitrate nitrogen and nitrite nitrogen.

The default values for kinetics and stoichiometric parameters of the conventional model, and the water quality parameters determined in 1) were used for simulation of parameters in relation to the mDON yielded in the wastewater treatment process; the simulation parameters were set as follows: \hat{μ}_{H}, 0.8 h⁻¹; Y_{H}, 0.67 mg(COD)/mg(N); b_{H}, 0.62 h⁻¹; K_{H,NH}, 0.05 mg(N)/L; K_{H,O}, 0.2 mg(N)/L; \hat{μ}_{A}, 0.3 h⁻¹; f_{H,DON}, 0.04; Y_{A}, 3.4 mg(COD)/mg(N); b_{A}, 0.15 h⁻¹; K_{A,NH}, 5 mg(N)/L; K_{A,O}, 0.4 mg(N)/L; f_{A,DON}, 0.04; i_{XB}, 0.07 mg(N)/mg(COD); i_{XP}, 0.03 mg(N)/mg(COD); f_{NO}, 0.8; f_{I}, 0.2; kₐ, 0.04 L/(mg(N) d); K_{H,DON}, 1.5 mg(N)/L; where H was the maximum specific growth rate of heterotrophic bacteria, Y_{H} was the yield coefficient of heterotrophic bacteria, b_{H} was the attenuation coefficient of heterotrophic bacteria, K_{H,NH} was the half-saturation constant for ammonia nitrogen of heterotrophic bacteria, K_{H,O} was the half-saturation constant for dissolved oxygen of heterotrophic bacteria, \hat{μ}_{A} was the maximum specific growth rate of autotrophic bacteria, f_{H,DON} was the substrate utilization ratio of heterotrophic bacteria converting the substrates into the mDON, Y_{A} was the yield coefficient of autotrophic bacteria, b_{A} was the attenuation coefficient of autotrophic bacteria, K_{A,NH} was the half-saturation constant for ammonia nitrogen of autotrophic bacteria, K_{A,O} was the half-saturation constant for dissolved oxygen of autotrophic bacteria, f_{A,DON} was the substrate utilization ratio of autotrophic bacteria converting the substrates into the mDON, i_{XB} was the proportion of nitrogen in the organism, i_{XP} was the proportion of nitrogen in the product of the organism, f_{NO} was the substrate utilization ratio of autotrophic bacteria converting the substrates into the nitrate nitrogen, f_{I} was the rate of inert particles yielded in the organism, kₐ was the ammonification rate, K_{H,DON} was the half-saturation constant for mDON.

3. Predicting the Concentration of mDON in Wastewater:

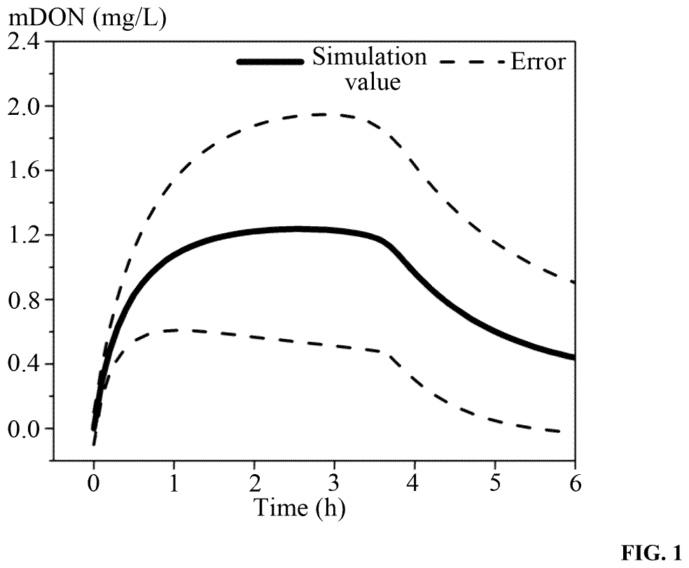

The components of influent and values of model parameters determined in 2) were fed into the software for modeling mDON to predict the concentration of the mDON in wastewater; where the single-step size was 0.1, and the calculation capacity was 60 steps, and the simulation process was based on the mDON participating in the biochemical reactions. The model-predicted result was shown in FIG. 1.

### Example 2

The example was the same as Example 1, except for the influent from the municipal wastewater treatment plant A. The operating parameters of the sequencing batch reactor: the influent temperature was 15° C., and hydraulic retention time was 8 h, activated sludge age was 20 d. The influent contains the following compositions: COD 96.2-120.6 mg/L, total nitrogen 23.7-29.1 mg/L, total phosphorus 2.0-3.5 mg/L, pH 7.4-8.0, and inert particles 3000-3200 mg/L. The influent (of greater than 200 mL) in the biological treatment process (i.e. oxidation ditch) and the activated sludge (of greater than 50 mL) were sampled for analysis of the components of the influent, as well as parameter estimation. The influent sample was then filtered using a cellulose acetate membrane filter having pore size of 0.45 μm. The COD was measured by using potassium dichromate method or rapid digestion method; the concentration of total nitrogen was measured by using potassium persulfate oxidation-ion chromatography, or potassium persulfate oxidation-ultraviolet spectrophotometry; the concentration of ammonia nitrogen was measured by using salicylic acid-hypochlorite spectrophotometry; the nitrate nitrogen was measured by using the ion chromatography or ultraviolet-visible spectrophotometry; the nitrite nitrogen was measured by using ion chromatography or N-(1-naphthyl)-ethylenediamine spectrophotometry; the concentration of dissolved organic nitrogen was the difference between the sum of total nitrogen and ammonia nitrogen and the sum of nitrate nitrogen and nitrite nitrogen. According to the parameters determined in 1), the initial values of the yield coefficient (Y_{H}) of heterotrophic bacteria, the attenuation coefficient of heterotrophic bacteria, and the maximum specific growth rate (\hat{μ}_{H}) of heterotrophic bacteria were 0.26 mgCOD/mgN, 0.09 h⁻¹, and 1.0 h⁻¹, respectively.

Building the ASM-mDON model and finding the optimal parameter values i_{XB} by parameter estimation: 0.07 mg(N)/mg(COD); kₐ, 0.04 L/(mg(N) d); \hat{μ}_{H}, 1.0 h⁻¹; Y_{H}, 0.30 mg(COD)/mg(N); b_{H}, 0.05 h⁻¹; K_{H,NH}, 0.05 mg(N)/L; K_{H},O, 0.2 mg(N)/L; \hat{μ}_{A}, 0.3 h⁻¹; f_{H,DON}, 0.04; Y_{A}, 3.4 mg(COD)/mg(N); b_{A}, 0.15 h⁻¹; K_{A,NH}, 5 mg(N)/L; K_{A,O}, 0.4 mg(N)/L; f_{A,DON}, 0.04; i_{XP}, 0.03 mg(N)/mg(COD); f_{NO}, 0.8; f_{I}, 0.2; K_{H,DON}, 1.5 mg(N)/L.

Predicting the concentration of the mDON in wastewater: the components of influent and values of model parameters determined in 2) were fed into the software for modeling mDON to predict the concentration of the mDON in wastewater; where the single-step size was 0.1, and the calculation capacity was 240 steps. The model-predicted concentration of the mDON yielded in the oxidation ditch was 2.32 mg/L.

### Example 3

The example was the same as Example 2, except for the influent coming from the municipal wastewater treatment plant A was sampled at different times. The operating parameters of the sequencing batch reactor: the influent temperature was 20° C., and hydraulic retention time was 8 h, activated sludge age was 5 d. The influent contains the following compositions: COD 96.2-120.6 mg/L, total nitrogen 23.7-29.1 mg/L, total phosphorus 2.0-3.5 mg/L, pH 7.4-8.0, and inert particles 3000-3200 mg/L. The influent (of greater than 200 mL) in the biological treatment process (i.e. oxidation ditch) and the activated sludge (of greater than 50 mL) were sampled for analysis of the components of the influent and parameter estimation. The influent sample was then filtered using a cellulose acetate membrane filter having pore size of 0.45 μm. COD was measured by using potassium dichromate method or rapid digestion method; the concentration of total nitrogen was measured by using potassium persulfate oxidation-ion chromatography, or potassium persulfate oxidation-ultraviolet spectrophotometry; the concentration of ammonia nitrogen was measured by using salicylic acid-hypochlorite spectrophotometry; the nitrate nitrogen was measured by using the ion chromatography or ultraviolet-visible spectrophotometry; the nitrite nitrogen was measured by using ion chromatography or N-(1-naphthyl)-ethylenediamine spectrophotometry; the concentration of dissolved organic nitrogen was the difference between the sum of total nitrogen and ammonia nitrogen and the sum of nitrate nitrogen and nitrite nitrogen. According to the parameters determined in 1), the initial values of the yield coefficient (Y_{H}) of heterotrophic bacteria, the attenuation coefficient of heterotrophic bacteria, and the maximum specific growth rate (\hat{μ}_{H}) of heterotrophic bacteria were 0.26 mgCOD/mgN, 0.09 h⁻¹, and 1.0 h⁻¹, respectively.

Building the ASM-mDON model and finding the optimal parameter values i_{XB} by parameter estimation: 0.07 mg(N)/mg(COD); kₐ, 0.04 L/(mg(N) d); \hat{μ}_{H}, 1.0 h⁻¹; Y_{H}, 0.30 mg(COD)/mg(N); b_{H}, 0.05 h⁻¹; K_{H,NH}, 0.05 mg(N)/L; K_{H,O}, 0.2 mg(N)/L; \hat{μ}_{A}, 0.3 h⁻¹; f_{H,DON}, 0.04; Y_{A}, 3.4 mg(COD)/mg(N); b_{A}, 0.15 h⁻¹; K_{A,NH}, 5 mg(N)/L; K_{A,O}, 0.4 mg(N)/L; f_{A,DON}, 0.04; i_{XP}, 0.03 mg(N)/mg(COD); f_{NO}, 0.8; f_{I}, 0.2; K_{H,DON}, 1.5 mg(N)/L.

Predicting the concentration of mDON in wastewater: the components of influent and values of model parameters determined in 2) were fed into the software for modeling mDON to predict the concentration of the mDON in wastewater; where the single-step size was 0.1, and the calculation capacity was 240 steps. The model-predicted concentration of the mDON yielded in the oxidation ditch was 1.89 mg/L.

### Example 4

The example was the same as Example 1, except for the influent from the municipal wastewater treatment plant B. The operating parameters of the sequencing batch reactor: the influent temperature was 20° C., and hydraulic retention time was 6 h, activated sludge age was 30 days. The influent contained the following compositions: COD 130.9 mg/L, total nitrogen 25.1 mg/L, total phosphorus 5.1 mg/L, pH 7.2, and inert particles 3000-3200 mg/L. The influent (of greater than 200 mL) in the biological treatment process (i.e. oxidation ditch) and the activated sludge (of greater than 50 mL) were sampled for analysis of the components of the influent and parameter estimation. The influent sample was then filtered using a cellulose acetate membrane filter having pore size of 0.45 μm. COD was measured by using potassium dichromate method or rapid digestion method; the concentration of total nitrogen was measured by using potassium persulfate oxidation-ion chromatography, or potassium persulfate oxidation-ultraviolet spectrophotometry; the concentration of ammonia nitrogen was measured by using salicylic acid-hypochlorite spectrophotometry; the nitrate nitrogen was measured by using the ion chromatography or ultraviolet-visible spectrophotometry; the nitrite nitrogen was measured by using ion chromatography or N-(1-naphthyl)-ethylenediamine spectrophotometry; the concentration of dissolved organic nitrogen was the difference between the sum of total nitrogen and ammonia nitrogen and the sum of nitrate nitrogen and nitrite nitrogen. According to the parameters determined in 1), the initial values of the yield coefficient (Y_{H}) of heterotrophic bacteria, the attenuation coefficient of heterotrophic bacteria, and the maximum specific growth rate (\hat{μ}_{H}) of heterotrophic bacteria were 0.2 mgCOD/mgN, 0.05 h⁻¹, and 0.3 h⁻¹, respectively.

Building the ASM-mDON model and finding the optimal parameter values i_{XB} by parameter estimation: 0.07 mg(N)/mg(COD); kₐ, 0.04 L/(mg(N) d); \hat{μ}_{H}, 0.33 h⁻¹; Y_{H}, 0.32 mg(COD)/mg(N); b_{H}, 0.05 h⁻¹; K_{H,NH}, 0.05 mg(N)/L; K_{H,O}, 0.2 mg(N)/L; \hat{μ}_{A}, 0.3 h⁻¹; f_{H,DON}, 0.04; Y_{A}, 3.0 mg(COD)/mg(N); b_{A}, 0.15 h⁻¹; K_{A,NH}, 5 mg(N)/L; K_{A,O}, 0.4 mg(N)/L; f_{A,DON}, 0.04; i_{XP}, 0.03 mg(N)/mg(COD); f_{NO}, 0.8; f_{I}, 0.2; K_{H,DON}, 1.5 mg(N)/L.

Predicting the concentration of mDON in wastewater: the components of influent and values of model parameters determined in 2) were fed into the software for modeling mDON to predict the concentration of the mDON in wastewater; where the single-step size was 0.1, and the calculation capacity was 60 steps. The model-predicted concentration of the mDON yielded in the oxidation ditch was 4.31 mg/L.

### Verification Example

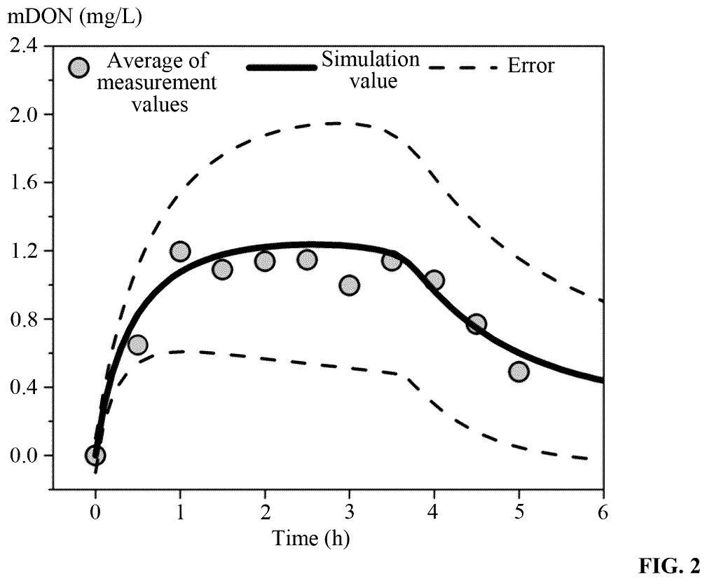

The Verification Example involves comparing the predicted values of mDON obtained through the ASM-mDON prediction model with actual measurements from a sequencing batch reactor (SBR), using the procedures detailed in Example 1 to ensure accuracy of the predictions of the ASM-mDON prediction model. Water samples were taken every 0.5 hours during a 5-hour reaction period within a single operational cycle of the SBR. The pre-treatment and measurement methods for the water samples followed the procedures detailed in Example 1. As illustrated in FIG. 2, the measured mDON production in the SBR over one cycle closely matched the simulated curve, staying within an acceptable error margin. Additionally, the ASM-mDON prediction model was utilized for further comparative validation. The variations in the operational parameters of the SBR satisfied the following conditions: hydraulic retention time (HRT) between 3 hours and 12 hours, activated sludge age between 5 days and 30 days, activated sludge concentration between 2000 mg/L and 5000 mg/L, carbon-to-nitrogen ratio (C/N) greater than 6, and daily nitrogen load per kilogram of activated sludge less than 0.07 kg TN. Using an orthogonal design, each operational parameter was set at five different levels. The different settings were input into the ASM-mDON prediction model to figure out which combination of the operational parameters produced the lowest concentration of mDON. The optimal combination of the operational parameters for minimizing the concentration of mDON in the SBR was as follows: a HRT of 6.4 hours, an activated sludge age of 20.1 days, an activated sludge concentration of 4333 mg/L, a C/N ratio of 23.6, and a daily nitrogen load of 0.04 kg TN per kilogram of activated sludge. Under the conditions, the concentration of mDON was reduced to 0.52 mg/L. The optimal combination of the operational parameters results in a 30% cost reduction compared to achieving similar mDON reductions through the addition of a carbon source.

It will be obvious to those skilled in the art that changes and modifications may be made, and therefore, the aim in the appended claims is to cover all such changes and modifications.

What is claimed is:

1. A method for reducing mDON concentration in wastewater, the method comprising:
a) integrating, by a data processor, a kinetic expression for microbial-derived dissolved organic nitrogen (mDON) into a conventional activated sludge model No. 1 (ASM1) to build an mDON predictive model;
b) inputting into software, by the data processor, component variables, parameter variables, model matrices, process rate equations, and operational parameters of the mDON predictive model to build an ASM-mDON predictive model;
c) inputting initial values, by the data processor, for the component variables and the parameter variables to initialize the ASM-mDON predictive model in software;
d) running, by the data processor, a preliminary simulation of mDON kinetics; conducting, by the data processor, a sensitivity analysis; and selecting corresponding parameters that impact the predictions of the ASM-mDON predictive model based on the results from the preliminary simulation and the sensitivity analysis,
e) calibrating, by parameter estimation feature in software, via the data processor, dynamic parameters and stoichiometric parameters in the ASM-mDON predictive model to obtain optimal values, thereby enhancing the accuracy of mDON concentration prediction;
f) replacing, by the data processor, the initial values for the dynamic parameters and the stoichiometric parameters in the ASM-mDON predictive model with the optimal values obtained from the calibration to optimize the ASM-mDON predictive model;
g) connecting a programmable logic controller via data signals to a dissolved oxygen sensor, a level sensor, a pH sensor, a plurality of actuators, and the data processor; collecting, by the programmable logic controller, the component variables and the parameter variables from the dissolved oxygen sensor, the level sensor, and the pH sensor; and transmitting, by the programmable logic controller, the collected data to the data processor;
h) inputting, by the data processor, the collected component variables and the parameter variables into the ASM-mDON predictive model, and outputting an mDON concentration;
i) inputting variations in operational parameters of an activated sludge system into the ASM-mDON predictive model to determine the changes in mDON concentration under different operational conditions; and identifying an optimal combination of the operational parameters that effectively reduce mDON production based on the model predictions; and
j) returning, by the data processor, the optimal combination of the operational parameters to the programmable logic controller; adjusting, by the programmable logic controller, the operational parameters of the plurality of actuators, thereby ensuring effective reduction in mDON concentration during wastewater treatment.

2. The method of claim 1, wherein the activated sludge system comprises a fully mixed steady state activated sludge; the activated sludge has a sludge age of 5-30 days, and a concentration of 2000-5000 mg/L.

3. The method of claim 1, wherein the ASM-mDON model is used for study of the mDON released by microorganisms in the activated sludge system, and the model comprises:
seven components: heterotrophic bacteria X_{H}, autotrophic bacteria X_{A}, inert particles X_{I}, nitrate nitrogen S_{NO}, ammonia nitrogen S_{NH}, microorganism-derived dissolved organic nitrogen S_{DON}, dissolved oxygen S_{O};
five reaction processes: a growth process and an endogenous respiration process of heterotrophic bacteria using ammonium chloride as a substrate; a growth process and an endogenous respiration process of autotrophic bacteria using ammonium chloride as a substrate; and an ammonization process of mDON; and
eighteen parameters: maximum specific growth rate \hat{μ}_{H} of heterotrophic bacteria, yield coefficient Y_{H} of heterotrophic bacteria, attenuation coefficient b_{H} of heterotrophic bacteria, half-saturation constant K_{H,NH} for ammonia nitrogen of heterotrophic bacteria, half-saturation constant K_{H,O} for dissolved oxygen of heterotrophic bacteria, maximum specific growth rate \hat{μ}_{A} of autotrophic bacteria, substrate utilization ratio f_{H,DON} of heterotrophic bacteria converting the substrate into the mDON, yield coefficient Y_{A} of autotrophic bacteria, attenuation coefficient b_{A} of autotrophic bacteria, half-saturation constant K_{A,NH} for ammonia nitrogen of autotrophic bacteria, half-saturation constant K_{A,O} for dissolved oxygen of autotrophic bacteria, substrate utilization ratio f_{A,DON} of autotrophic bacteria converting the substrate into the mDON, proportion of nitrogen i_{XB} in an organism, proportion of nitrogen i_{XP} in the product of the organism, substrate utilization ratio f_{NO} of autotrophic bacteria converting the substrate into the nitrate nitrogen, proportion of inert particles f₁ yielded in the organism, ammonification rate kₐ, and half-saturation constant K_{H,DON} for mDON.

4. The method of claim 3, wherein change rates of the seven components of the ASM-mDON model satisfy with the following formulas:
$${X}_{H} \text{:} \frac{{dX}_{H}}{d t} = {\hat{μ}}_{H} {M}_{H , NH} ( t ) {M}_{H , O} ( t ) {X}_{H} ( t ) - {b}_{H} {M}_{H , O} ( t ) {X}_{H} ( t ) \qquad ( 1 )$$
$${X}_{A} \text{:} \frac{{dX}_{A}}{dt} = {\hat{μ}}_{A} {M}_{A , NH} ( t ) {M}_{A , O} ( t ) {X}_{A} ( t ) - {b}_{A} {M}_{A , O} ( t ) {X}_{A} ( t ) \qquad ( 2 )$$
$${S}_{NH} \text{:} \frac{d {S}_{N H}}{d t} = - ( \frac{{f}_{H , DON}}{{Y}_{H}} + {i}_{XB} ) {\hat{μ}}_{H} {M}_{H , NH} ( t ) {M}_{H , O} ( t ) {X}_{H} ( t ) - ( \frac{{f}_{A , DON} + {f}_{NO}}{{Y}_{A}} + {i}_{XB} ) {\hat{μ}}_{A} {M}_{A , N H} ( t ) {M}_{A , O} ( t ) {X}_{A} ( t ) + {k}_{a} {M}_{H , DON} ( t ) {X}_{H} ( t ) \qquad ( 3 )$$
$${S}_{DON} \text{:} \frac{d {S}_{D O N}}{d t} = \frac{{f}_{H , DON}}{{Y}_{H}} {\hat{μ}}_{H} {M}_{H , NH} ( t ) {M}_{H , O} ( t ) {X}_{H} ( t ) + \frac{{f}_{A , DON}}{{Y}_{A}} {\hat{μ}}_{A} {M}_{A , N H} ( t ) {M}_{A , O} ( t ) {X}_{A} ( t ) - {k}_{a} {M}_{H , DON} ( t ) {X}_{H} ( t ) \qquad ( 4 )$$
$${S}_{NO} \text{:} \frac{{dS}_{NO}}{dt} = \frac{{f}_{NO}}{{Y}_{A}} {\hat{μ}}_{A} {M}_{A , NH} ( t ) {M}_{A , O} ( t ) {X}_{A} ( t ) \qquad ( 5 )$$
$${X}_{I} : \frac{{dX}_{I}}{dt} = {f}_{I} {b}_{H} {M}_{H , O} ( t ) {X}_{H} ( t ) + {f}_{I} {b}_{A} {M}_{A , O} ( t ) {X}_{A} ( t ) \qquad ( 6 )$$
$${S}_{O} : \frac{{dS}_{O}}{dt} = {k}_{L} α ( {S}_{O}^{*} - {S}_{O} ) - ( 1 - \frac{2.86 {f}_{H , DON}}{{Y}_{H}} ) {\hat{μ}}_{H} {M}_{H , NH} ( t ) {M}_{H , O} ( t ) {X}_{H} ( t ) - ( 1 - \frac{2 \text{.86} {f}_{A , DON}}{{Y}_{A}} - \frac{4 \text{.57} {f}_{NO}}{{Y}_{A}} ) {\hat{μ}}_{A} {M}_{A , NH} ( t ) {M}_{A , O} ( t ) {X}_{A} ( t ) + ( {i}_{XB} - {f}_{I} {i}_{XP} ) {b}_{H} {M}_{H , O} ( t ) {X}_{H} ( t ) + ( {i}_{XB} - {f}_{I} {i}_{XP} ) {b}_{A} {M}_{A , O} ( t ) {X}_{A} ( t ) \qquad ( 7 )$$
M_{H,NH} (t) is a Monod term determined by the substrate for the heterotrophic bacteria; M_{A,NH} (t) is a Monod term determined by the substrate for the autotrophic bacteria; M_{H,O} (t) is a Monod term determined by the dissolved oxygen for the heterotrophic bacteria; M_{A,O} (t) is a Monod term determined by the dissolved oxygen for the autotrophic bacteria; M_{H,DON}(t) is a Monod term determined by the mDON in the heterotrophic bacteria; k_{L}α is an exchange rate between a gas phase and a liquid phase; and S_{O}* is a maximum solubility of oxygen.

5. The method of claim 3, wherein the mDON in wastewater is calculated using the following kinetic equation:
$$\frac{{dS}_{D O N}}{dt} = \frac{{f}_{H , DON}}{{Y}_{H}} {\hat{μ}}_{H} {M}_{H , NH} ( t ) {M}_{H , O} ( t ) {X}_{H} ( t ) + \frac{{f}_{A , DON}}{{Y}_{A}} {\hat{μ}}_{A} {M}_{A , NH} ( t ) {M}_{A , O} ( t ) {X}_{A} ( t ) - {k}_{a} {M}_{H , DON} ( t ) {X}_{H} ( t ) . \qquad ( 8 )$$

6. The method of claim 3, wherein a single-step size of the AMS-mDON model is 0.1, and a total response time for the predictive model is a product of a calculation capacity and the single-step size.

7. The method of claim 1, wherein in (g), collecting the component variables and the parameter variables comprises filtering an influent sample from a wastewater treatment plant using a membrane filter; measuring chemical oxygen demand (COD), concentrations of total nitrogen, nitrate nitrogen, nitrite nitrogen, ammonia nitrogen, and dissolved organic nitrogen of the influent sample filtered, respectively; and measuring yield coefficient Y_{H} of heterotrophic bacteria, attenuation coefficient b_{H} heterotrophic bacteria, and maximum specific growth rate \hat{μ}_{H} of heterotrophic bacteria for the activated sludge.

8. The method of claim 7, wherein the wastewater treatment plant operates at an ambient temperature ranging from 15 to 25° C., and an influent pH thereof is 6.0-8.0.

9. The method of claim 7, wherein the concentration of the dissolved organic nitrogen is a difference between concentrations of total nitrogen and ammonia nitrogen, nitrate nitrogen and nitrite nitrogen; the concentration of the total nitrogen is measured by using potassium persulfate oxidation-ion chromatography, or potassium persulfate oxidation-ultraviolet spectrophotometry; the concentration of the ammonia nitrogen is measured by using salicylic acid-hypochlorite spectrophotometry; the concentration of the nitrate nitrogen is measured by using the ion chromatography or ultraviolet-visible spectrophotometry; the concentration of the nitrite nitrogen is measured by using ion chromatography or N-(1-naphthyl)-ethylenediamine spectrophotometry; and the COD is measured by using potassium dichromate method or rapid digestion method.

10. The method of claim 1, wherein in (i), the variations in operational parameters satisfy the following conditions: hydraulic retention time (HRT) between 3 hours and 12 hours, activated sludge age between 5 days and 30 days, activated sludge concentration between 2000 mg/L and 5000 mg/L, carbon-to-nitrogen ratio (C/N) greater than 6, and daily nitrogen load per kilogram of activated sludge less than 0.07 kg TN.
